(19) United States
(12) Patent Application Publication
(10) Pub. No.: US 2016/0132127 A1
(43) Pub. Date: May 12, 2016

(54) Method and Device for Determining User Input on Basis of Visual Information on User's Fingernails or Toenails

(71) Applicant: FuturePlay Inc., Seoul (KR)

(72) Inventor: Sung Jae HWANG, Seoul (KR)

(73) Assignee: FuturePlay Inc.

(21) Appl. No.: 14/980,951

(22) Filed: Dec. 28, 2015

Related U.S. Application Data
(63) Continuation-in-part of application No. PCT/KR2014/005767, filed on Jun. 27, 2014.

(30) Foreign Application Priority Data
Jun. 27, 2013 (KR) KR10-2013-0074438

(51) Int. Cl. G06F 3/01; G06F 3/00

(52) U.S. Cl. CPC G06F 3/017; G06F 3/005

(57) ABSTRACT

According to one aspect of the present invention, there is provided a method comprising the steps of: acquiring first information on an action performed or a form made by a user and second information on the user's fingernails or toenails, wherein the second information is visual information; and determining the user's input by determining a first element of the user's input on the basis of the first information and determining a second element of the input on the basis of the second information.

### PRIORITY CLAIM

This application is a continuation-in-part application of Patent Cooperation Treaty (PCT) international application Serial No. PCT/KR2014/005767, filed on Jun. 27, 2014 and which designates the United States, which claims the benefit of the filing date of Korean Patent Application Serial No. 10-2013-0074438, filed on Jun. 27, 2013. The entirety of both PCT international application Serial No. PCT/KR2014/005767 and Korean Patent Application Serial No. 10-2013-0074438 are incorporated herein by reference.

### FIELD OF THE INVENTION

The present invention relates to a method and a device for determining a user input on the basis of visual information on a user's fingernails or toenails.

### BACKGROUND

With the development of electronics/computer technologies, various kinds of user input means are being used for diverse electronic devices/computers.

Among those user input means, keyboards, mice, electronic pens, styluses and the like are widely known. Such user input means may actively and directly generate an electronic signal so that a user input can be made accurately. However, the user input means are required to be purposely provided in addition to or separately from a device for which the user input is made.

Meanwhile, there exists a gesture recognition-based technique for determining a user input on the basis of a position or form of a hand, a form of a body, or the like made by a user and recognized by an imaging means such as a camera. This conventional technique requires no separate user input means other than the camera, but has a drawback in that the user should bother to learn various gestures which may not be intuitive.

In this situation, the inventor(s) suggest herein novel user inputs and present a technique to enable these user inputs to be utilized alone or in combination with other existing user inputs.

### SUMMARY OF THE INVENTION

One object of the present invention is to solve all the above-described problems in prior art.

Another object of the invention is to enable a user to provide a user input using fingernails or toenails.

Yet another object of the invention is to specifically determine a user input when a user performs an action or makes a form with a hand or foot, with reference to information on the action or form and visual information on fingernails or toenails of the corresponding hand or foot.

According to one aspect of the invention to achieve the above objects, there is provided a method comprising the steps of: acquiring first information on an action performed or a form made by a user and second information on the user's fingernails or toenails, wherein the second information is visual information; and determining the user's input by determining a first element of the user's input on the basis of the first information and determining a second element of the input on the basis of the second information.

In addition, there are further provided other methods and systems to implement the invention, as well as computer-readable recording media having stored thereon computer programs for executing the methods.

According to the invention, a user may provide a user input using fingernails or toenails.

According to the invention, a user input may be specifically determined when a user performs an action or makes a form with a hand or foot, with reference to information on the action or form and visual information on fingernails or toenails of the corresponding hand or foot

### BRIEF DESCRIPTION OF THE DRAWINGS

FIG. 1 schematically shows the configuration of a device for determining a user input on the basis of visual information on a user's fingernails or toenails according to one embodiment of the invention.

FIG. 2 shows correspondence relations which may be considered to be preferable according to one embodiment of the invention.

FIG. 3 shows a correspondence relation which may be considered to be preferable according to another embodiment of the invention.

FIG. 4 shows a situation in which a user wears a first device being a smart glass on eyes and observes his/her touch input to a second device being a smart phone according to one embodiment of the invention.

FIG. 5 shows a situation in which a user wears a device being a smart glass on eyes and observes an input made by his/her fingernails according to one embodiment of the invention.

FIG. 6 shows a situation in which a user wears a device being a smart glass on eyes and observes an input made by fingernails of his/her hands holding a steering wheel of a car according to one embodiment of the invention.

FIG. 7 shows a situation in which a user wears a first device being a smart glass on eyes and controls a second device being a ceiling-mounted air conditioner according to one embodiment of the invention.

FIG. 8 shows a situation in which a user wears a device being a smart glass on eyes and provides an input with an image projected onto the user's palm by the device according to one embodiment of the invention.

FIG. 9 shows a situation in which a user wears a first device being a smart glass on eyes and performs zoom-in/zoom-out on a second device being a smart pad using multi-touch according to one embodiment of the invention.

FIG. 10 shows a situation in which a user wears a device being a smart glass on eyes and turns a page of a book according to one embodiment of the invention.

FIG. 11 shows a situation in which a user wears a first device being a smart glass on eyes and issues a control command to a second device being a smart watch according to one embodiment of the invention.

### DETAILED DESCRIPTION OF THE PREFERRED EMBODIMENTS

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each of the embodiments may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

Device Configuration

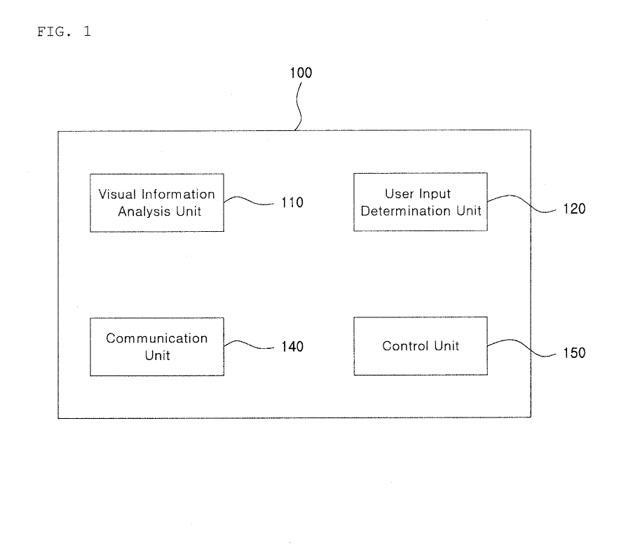

FIG. 1 schematically shows the configuration of a device for determining a user input on the basis of visual information on a user's fingernails or toenails according to one embodiment of the invention.

A device 100 according to one embodiment of the invention may be any type of digital equipment having a memory means and a microprocessor for computing capabilities. The device 100 may acquire visual information on a user's fingernails or toenails. To this end, the device 100 may include an imaging device such as a camera (not shown). Meanwhile, the device 100 may be a ring or band-type device being placed around the user's fingernails or toenails and capable of acquiring visual information thereon. In this case, the device may include an imaging means (not shown) or include a pulse wave sensor (not shown), a PPG sensor (not shown), or an oxygen saturation sensor (not shown) on a surface contacting or facing the user's fingernails or toenails. Here, a thermal infrared sensor (not shown) may be used together with or in place of the above sensors. Further, for example, the device 100 may be a smart device such as a smart phone, a smart pad, a smart glass, and a smart watch, or may be a somewhat traditional device such as a desktop computer, a notebook computer, a workstation, a personal digital assistant (PDA), a web pad, a mobile phone, a head-mounted display (HMD), a television, and a set-top box.

Meanwhile, even when an active sensor such as a pulse wave sensor, PPG sensor, or oxygen saturation sensor is employed, the device 100 may acquire visual information according to various input actions of the user to be described below, i.e., optical information on the fingernails or toenails, or the vicinity thereof, which is detected by the sensor. This may also be the visual information to be analyzed as will be described below. Further, when a thermal infrared sensor is employed, heat distribution information on the fingernails or toenails, or the vicinity thereof, may be acquired. This may be used together with or in place of the above visual information.

As shown in FIG. 1, the device 100 may comprise a visual information analysis unit 110, a user input determination unit 120, a communication unit 140, and a control unit 150. According to one embodiment of the invention, at least some of the visual information analysis unit 110, the user input determination unit 120, the communication unit 140, and the control unit 150 may be program modules. The program modules may be included in the device 100 in the form of operating systems, application program modules, or other program modules, while they may be physically stored on a variety of commonly known storage devices. Further, the program modules may also be stored in a remote storage device that may communicate with the device 100. Meanwhile, such program modules may include, but not limited to, routines, subroutines, programs, objects, components, data structures, and the like for performing specific tasks or executing specific abstract data types as will be described below in accordance with the invention.

First, the visual information analysis unit 110 according to one embodiment of the invention may function to acquire and analyze visual information on a user's fingernails or toenails.

The visual information analysis unit 110 may first receive an original image captured by a camera, i.e., an original image including an image of the user's fingernails or toenails.

The visual information analysis unit 110 may then perform a process to separate a foreground and a background from the original image. To this end, the visual information analysis unit 110 may use a known skin color model or a circular feature descriptor to distinguish the portions having a greater possibility of being the image of the user's fingernails or toenails from those having a lesser possibility.

Finally, the visual information analysis unit 110 may perform a known erosion operation on the separated foreground image having the greater possibility of being the image of the user's fingernails or toenails, and then perform filtering to remove noise by passing, among the resulting blobs, only those having a size not less than a threshold value.

Thus, the visual information analysis unit 110 may acquire the visual information on the user's fingernails or toenails, which is appropriate for a user input. The visual information may be utilized by the user input determination unit 120 as will be described below.

Meanwhile, the visual information analysis unit 110 may further analyze an image of the vicinity of the user's fingernails or toenails (e.g., skin regions next to the fingernails) other than the fingernails or toenails. This stems from the idea that when the image of the fingernails or toenails is significant, the color or the like of the vicinity thereof tends to be changed and thus the image thereof may be required to be analyzed together.

Meanwhile, the visual information analysis unit 110 may also analyze visual information acquired by the above-described active sensor.

Further, although it has been mainly described above that the visual information analysis unit 110 analyzes the visual information on the user's fingernails or toenails, the visual information analysis unit 110 may further analyze the user's action on the basis of a plurality of images (preferably, a plurality of images sequentially acquired by the imaging means) acquired with respect to the user's corresponding fingers, hand including the fingers, arm including the hand, or other body parts (this naturally applies to the toes, foot, leg, or the like). To this end, the visual information analysis unit 110 may include a known motion analysis module for analyzing the plurality of sequentially acquired images. The motion analysis module may analyze motion over time of hands, fingers, fingernails or the like, which may be particularly characteristic parts among the user's body parts. Information on the user's action, which is derived from the analysis, may be employed by the user input determination unit 120 to be described below.

Further, although analyzing the visual information on the user's fingernails or toenails has been mainly described, the visual information analysis unit 110 may further analyze a form made by the user on the basis of an image (preferably, an image acquired by the imaging means) acquired with respect to the user's corresponding fingers, hand including the fingers, arm including the hand, or other body parts (this naturally applies to the toes, foot, leg, or the like). Information on the form made by the user, which is derived from the analysis, may be employed by the user input determination unit 120 to be described below.

Next, the user input determination unit 120 may determine the user's input on the basis of the visual information on the user's fingernails or toenails, which is provided from the visual information analysis unit 110.

Preferred examples of the above user inputs include the following:

(1) A finger or toe being bent (one or more joints being bent)

In this case, the portion of the fingernail or toenail having a white color (or a similar or corresponding color depending on races) may be changed to have a red or pink color (or a similar or corresponding color depending on races). Further, the gloss of the fingernail or toenail may be changed.

(2) A finger or toe being straightened (one or more bent joints being spread)

In this case, the middle portion of the fingernail or toenail may temporarily have a white color. Further, the gloss of the fingernail or toenail may be changed.

(3) A finger or toe applying pressure (to an object)

In this case, the portion around the end of the fingernail or toenail may have a white color.

(4) Two or more fingers applying pressure to each other (the fingers being pressed against each other)

In this case, the portions around the ends of the fingernails of the contacting fingers may have a white color.

(5) A finger or toe being rolled (being rotated about a virtual line in the longitudinal direction of the finger or toe serving as a central axis)

In this case, the gloss of the fingernail or toenail may be changed.

Specifically, the visual information on the fingernails or toenails in the above examples may be a RGB or CMYK value of a specific region of the fingernails or toenails, but may also be shading, brightness, saturation, gloss level, or the like. The region used to specify such a value may be the entirety of the fingernails or toenails, but may also be a part thereof.

According to the experiments of the inventor(s), the aspect of the above change in the color or gloss of the fingernails or toenails tends to be regular, rather than be varied, for each user. Therefore, on the basis of the above-described visual information, the user input determination unit 120 may determine a corresponding user input as a specified input. The correspondence relations may be pre-stored in a storage (not shown) in the device 100.

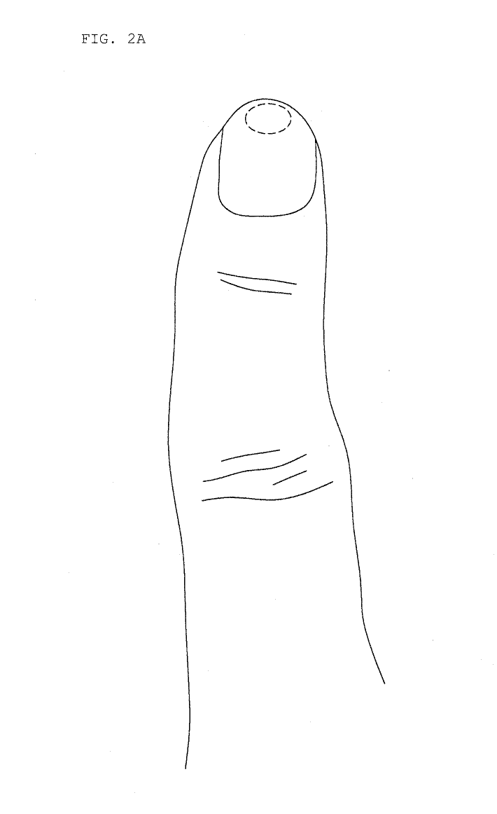

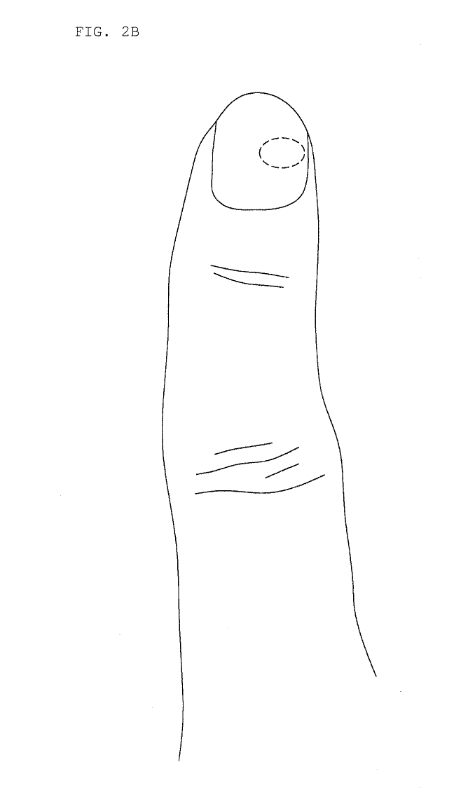

The correspondence relations, which may be considered to be preferable according to embodiments of the invention, will be discussed in detail below with reference to FIG. 2. In the following description, it is assumed that a user input is determined as a user uses a finger. However, it is apparent to those skilled in the art that the user input may be similarly determined even when the user uses a toe.

When the user applies pressure straight to an object using the finger, the portion indicated by a broken line in FIG. 2A (i.e., the portion around the end of the fingernail) or those adjacent thereto may have a white color. Thus, the user input determination unit 120 may measure the color value (e.g., RGB or CMYK value) of the above portion in the image of the fingernail provided from the visual information analysis unit 110, or the variation in the value before and after the application of the pressure, and then determine the user input to be the application of the pressure by the finger. The application of the pressure may be intuitively and naturally recognized and considered as a user selection action such as a click or touch. The selection may be made for a specific visual object shown on a display means (not shown) included in or associated with the device 100. Of course, the selection may also be made for the entire contents being displayed, rather than for an object. Further, those skilled in the art may define a correspondence relation such that the above selection is considered to be made for any other objects or events.

Meanwhile, when the user applies pressure to an object using the finger, with the finger being turned sideways or rolled to a certain extent, the portion indicated by a broken line in FIG. 2B or 2C or those adjacent thereto may have a white color. Thus, the user input determination unit 120 may measure the color value (e.g., RGB or CMYK value) of the above portion in the image of the fingernail provided from the visual information analysis unit 110, or the variation in the value before and after the application of the pressure, and then determine the user input to be the different type of application of the pressure by the finger. The application of the pressure may be recognized and considered as a different type of selection or operation (e.g., an operation for moving a specific object or cursor to the left or right).

Meanwhile, when the user spreads the bent finger, the portion indicated by a broken line in FIG. 2D or those adjacent thereto may temporarily have a white color. Thus, the user input determination unit 120 may measure the color value (e.g., RGB or CMYK value) of the above portion in the image of the fingernail provided from the visual information analysis unit 110, or the variation in the value before and after the action, and then determine the user input to be interruption or cancellation of a specific selection or operation.

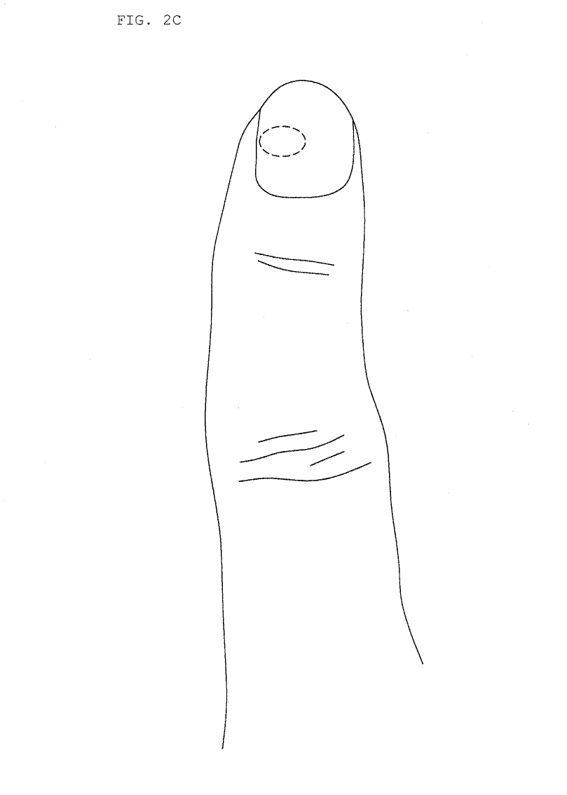

The correspondence relation, which may be considered to be preferable according to another embodiment of the invention, will be further discussed below with reference to FIG. 3.

When a user joins two fingers together and presses them against each other as shown in FIG. 3, the portions around the ends of the fingernails may have a white color. Thus, the user input determination unit 120 may measure the color value (e.g., RGB or CMYK value) of the above portions in the image of the fingernails provided from the visual information analysis unit 110, or the variation in the value before and after the pressing, and then determine the user input to be the mutual application of the pressure by the two fingers. The user action may be particularly advantageous in that it allows the user to generate the user input using only his/her fingers without depending on an object.

Meanwhile, the user input determination unit 120 may also determine the user's input on the further basis of the visual information on the vicinity of the fingernails or toenails as described above.

Although the user input determination unit. 120 may determine a user input on the basis of an image of fingernails as described above, the determined input can be used together with other conventional user inputs, e.g., those according to a gesture recognition-based technique which employs positions or forms of a user's fingers, or positions of fingernails thereof. That is, the user input determination unit 120 may specify a position (e.g., a position on a display of the device 100) where a user desires to generate an input, on the basis of a position of a finger or fingernail of the user according to a conventional technique, and determine the user input that the user desires to generate at the specified position, on the basis of an image of the fingernail of the user according to the invention. For example, when the user presses, bends, or spreads a finger, or joins two or more fingers together and presses them against each other, with the finger(s) being placed at a specific position in front of a camera, so that the color of the fingernail(s) is changed, the user input determination unit 120 may cause a user input corresponding to the color change to be determined and then generated at a position on the display corresponding to the specific position. In this case, the user input determination unit 120 may determine the type or degree/intensity of the generated user input to be varied with the size or distribution of the color values (e.g., RGB or CMYK values) in the image of the fingernail(s). For example, this function may be implemented such that the user changes the color of the fingernail(s) to perform zoom-in/zoom-out on the display of the device 100 or change the output (e.g., sound output) of the device 100.

Similarly, the user input determination unit 120 may determine a user input with reference to information on an action performed or a form made by a user. Here, the user input may be determined with further reference to visual information on an image of fingernails or the like. For example, the information on the user's action or the form of the user's body part may determine a first element of the user input, and the visual information on the image of the user's fingernails may determine a second element of the user input. In this case, the first element may represent the direction of the user input and the second element may represent the intensity of the user input. Otherwise, the first element may represent the type of the user input and the second element may represent the direction of the user input. Otherwise, the first element may represent triggering of the user input and the second element may represent the direction and intensity of the user input. In connection with various examples of the user input which may be compositive as above, reference may be made to Section 2 below.

Next, the communication unit 140 according to one embodiment of the invention may function to enable data transmission/receipt between the device 100 and an external device (not shown), or data transmission/receipt to/from the visual information analysis unit 110 and the user input determination unit 120. To this end, the communication unit 140 may include a variety of conventional communication modules. The communication modules may be commonly known electronic communication components that may join a variety of communication networks (not shown) such as local area networks (LANs), metropolitan area networks (MANs), and wide area networks (WANs). Preferably, the communication networks may be the Internet or the World Wide Web (WWW). However, the communication networks are not necessarily limited thereto, and may at least partially include known wired/wireless data communication networks, known telephone networks, or known wired/wireless television communication networks.

Lastly, the control unit 150 according to one embodiment of the invention may function to control data flow among the visual information analysis unit 110, the user input determination unit 120, and the communication unit 140. That is, the control unit 150 according to the invention may control data flow into/out of the device 100, or data flow among the respective components of the device 100, such that the visual information analysis unit 110, the user input determination unit 120, and the communication unit 140 may carry out their particular functions, respectively.

Examples of User Input Determination

The user input determination as described above may be implemented in slightly different aspects in individual user scenarios. Examples of the user input determination will be discussed below with reference to the drawings.

1. Examples of determination based on visual information on a user's fingernails or the like

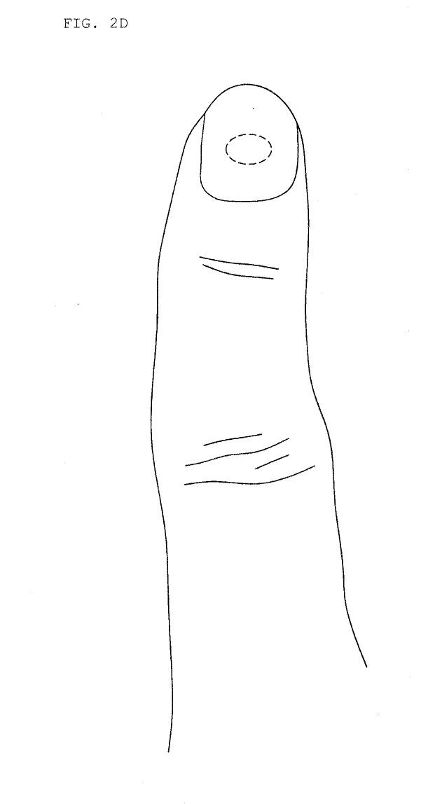

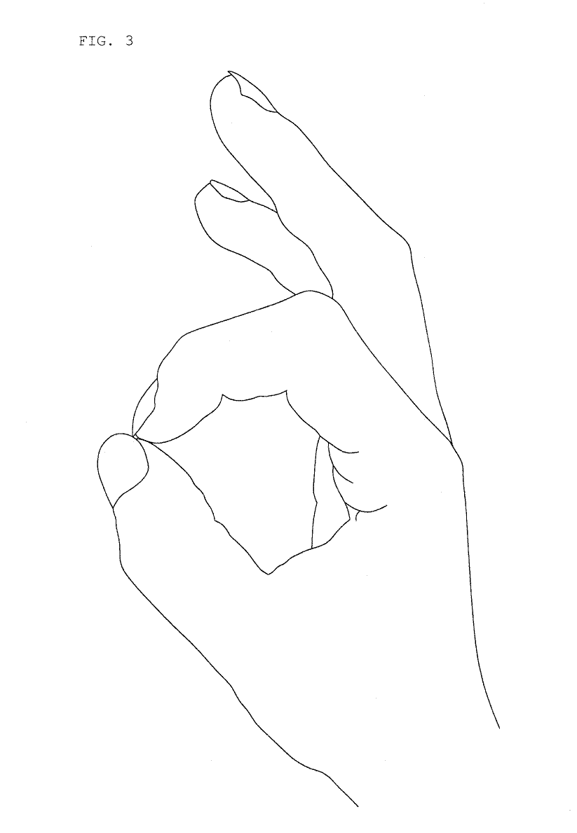

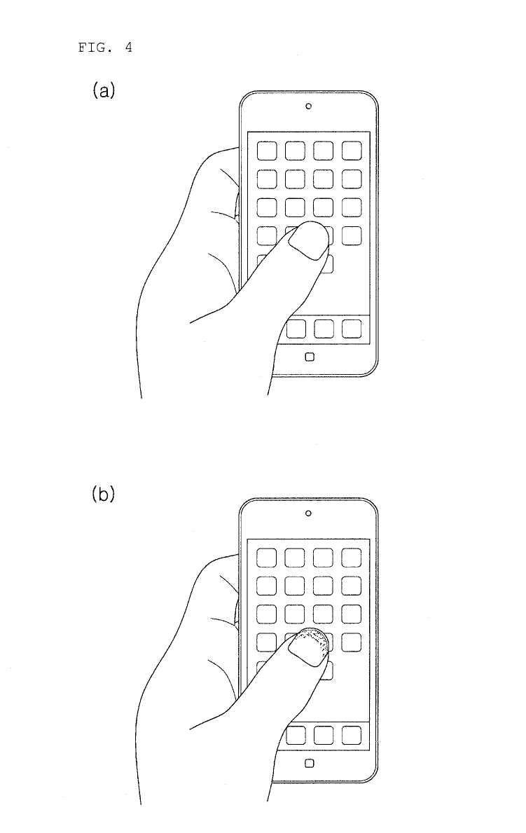

FIG. 4 shows a situation in which a user wears a first device being a smart glass on eyes and observes his/her touch input to a second device being a smart phone according to one embodiment of the invention. Here, the first device is not shown.

In a normal situation as shown in (a) of FIG. 4, the user may be comfortably holding the second device in one hand. In this situation, among the user's fingernails, that of the finger contacting a touch panel of the second device (i.e., the thumb) is not particularly different than usual.

However, when the user applies significant pressure to the touch panel of the second device with the thumb as shown in (b) of FIG. 4, the color of the corresponding fingernail may fall within the case (3) above. The first device may analyze an image thereof to recognize that the user is applying significant pressure to the second device, i.e., providing a user input, without any information from the second device. Meanwhile, it should be noted that the portion of the fingernail being changed to have a white color is marked with multiple dots as shown in (b) of FIG. 4, for convenience of illustration. This manner of illustrating the fingernail color also applies to the following drawings.

FIG. 5 shows a situation in which a user wears a device being a smart glass on eyes and observes an input made by his/her fingernails according to one embodiment of the invention. Here, the device is not shown.

In normal situations as respectively shown in (a), (c), (e) and (g) of FIG. 5, the user may be comfortably spreading a hand (see (a)), making a form of OK with a hand (see (c)), comfortably spreading a thumb (see (e)), or lightly holding an object (see (g)). However, as respectively shown in (b), (d), (f) and (h) of FIG. 5, the user may be firmly spreading out the hand (see (b)), firmly pressing two fingers making “0” against each other while making the form of OK with the hand (see (d)), firmly spreading out the thumb (see (f)), or relatively tightly holding the object (see (h)). The device of the user may analyze an image thereof to recognize that the user is providing a user input using the fingers.

Here, the user inputs as shown in the respective pairs of (a)-(b), (c)-(d), (e)-(f) and (g)-(h) of FIG. 5 may be significantly useful when they are made with respect to objects in virtual reality.

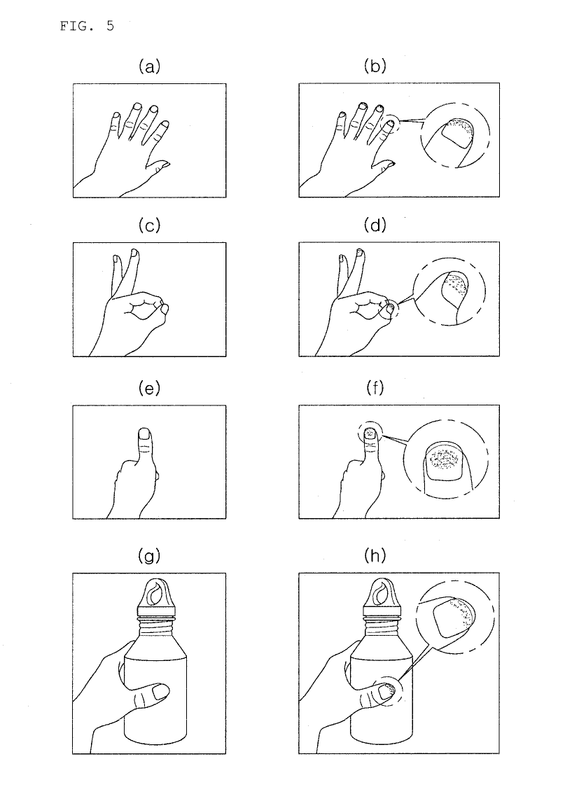

FIG. 6 shows a situation in which a user wears a device being a smart glass on eyes and observes an input made by fingernails of his/her hands holding a steering wheel of a car according to one embodiment of the invention. Here, the device is not shown.

Regardless of whether the user's eyes are actually looking at something, the device may observe the fingernails of the hands while the user is holding the steering wheel of the car to check whether the user is properly holding the steering wheel. If the user is not properly holding the steering wheel of the car due to dozing off or the like, the device may recognize it and generate an alarm sound via an internal or external speaker or the like.

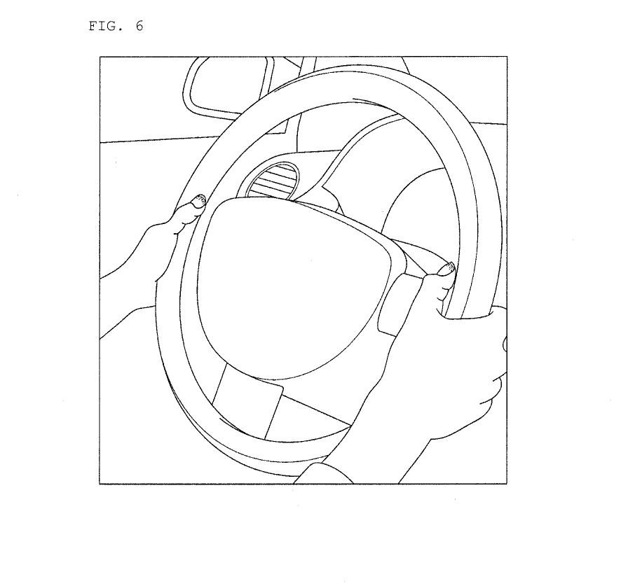

FIG. 7 shows a situation in which a user wears a first device being a smart glass on eyes and controls a second device being a ceiling-mounted air conditioner according to one embodiment of the invention.

When the user moves fingers while looking at the second device with the first device being worn on eyes so that the color or the like of the fingernails is changed, the first device may visually recognize the color change of the fingernails and the second device indicated thereby all together. In this case, the visual information analysis unit 110 of the first device may recognize the color change or the like of the fingernails as a control input for the second device.

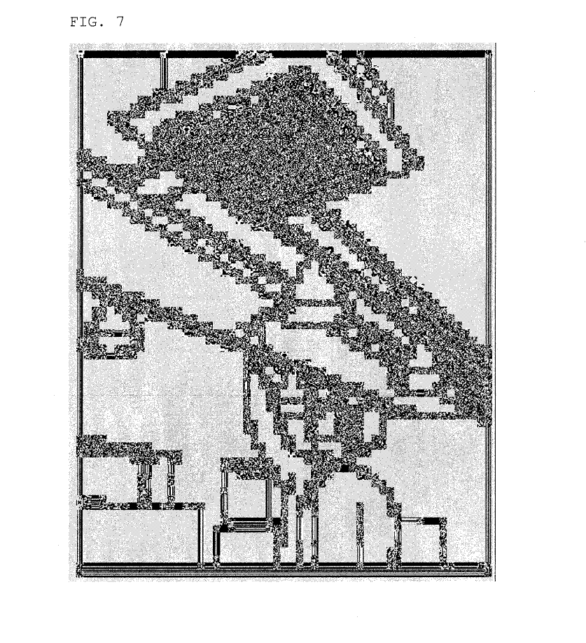

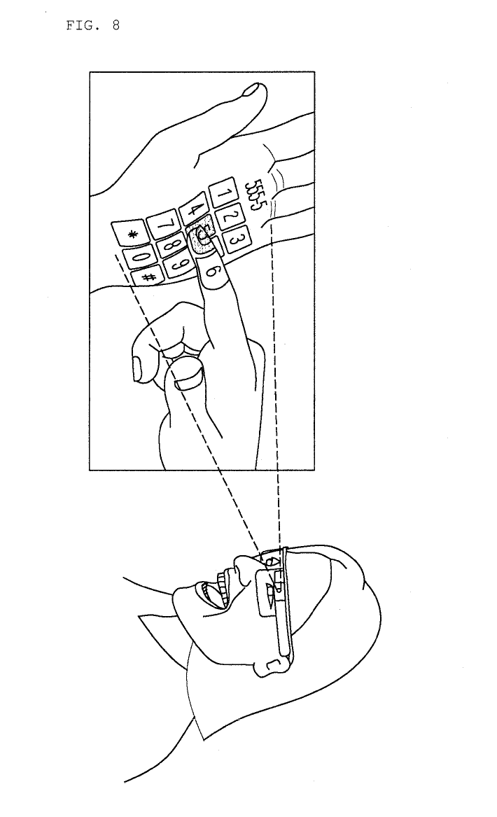

FIG. 8 shows a situation in which a user wears a device being a smart glass on eyes and provides an input with an image projected onto the user's palm by the device according to one embodiment of the invention.

When the user uses a finger to apply pressure to one dial button on a dial pad image projected onto the user's palm (which may be projected from the device to the palm) with the device being worn on eyes, the device may recognize that the corresponding number is pressed according to the color change or the like of the fingernail of the corresponding finger. The principle of the user input may prevent the push input as above from being erroneously detected when the user moves the finger on the dial pad image projected onto the palm without applying pressure.

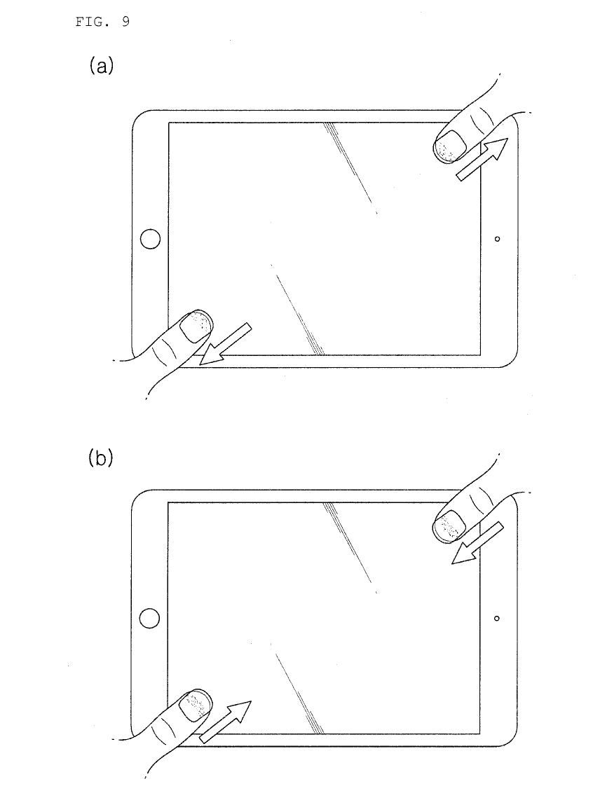

FIG. 9 shows a situation in which a user wears a first device being a smart glass on eyes and performs zoom-in/zoom-out on a second device being a smart pad using multi-touch according to one embodiment of the invention. Here, the first device is not shown.

The user may observe his/her fingers touching the second device held by the user with the first device being worn on eyes. In this situation, when the fingernails of the two observed fingers have a color as shown in (a) (i.e., when the ends of the two opposite fingernails are changed to have a white color), the visual information analysis unit 110 of the first device may analyze an image thereof to recognize that the user is attempting zoom-out on the second device. In the case of (b) as shown (i.e., when the portions closer to the centers of the two opposite fingernails, not the ends thereof, are changed to have a white color), it may be recognized that the user is attempting zoom-in, on the contrary.

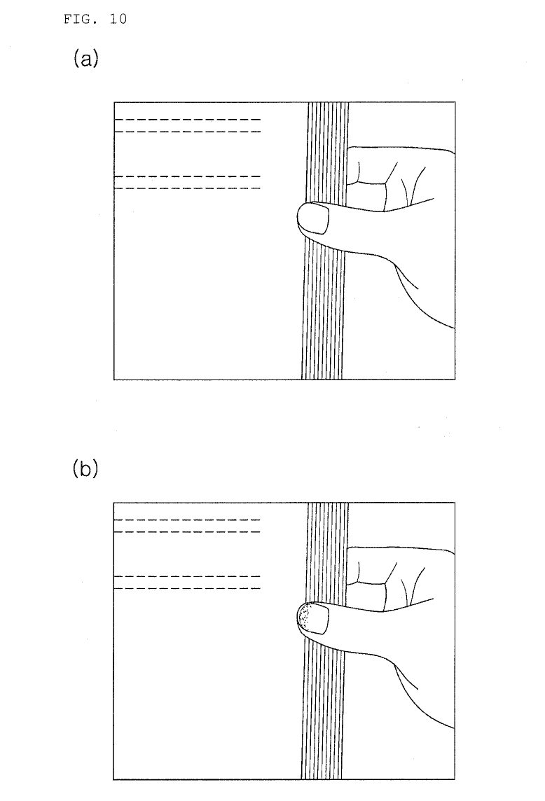

FIG. 10 shows a situation in which a user wears a device being a smart glass on eyes and turns a page of a book according to one embodiment of the invention. Here, the device is not shown.

The user may observe his/her finger touching the book held by the user with the device being worn on eyes. In this situation, when the fingernail of the observed finger has a color as shown in (a) (i.e., when the color of the fingernail is not particularly changed), the visual information analysis unit 110 of the device may analyze an image thereof to recognize that the user is simply holding the book. In the case of (b) as shown (i.e., when the end of the fingernail is changed to have a white color), it may be recognized that the user is firmly turning a page of the book.

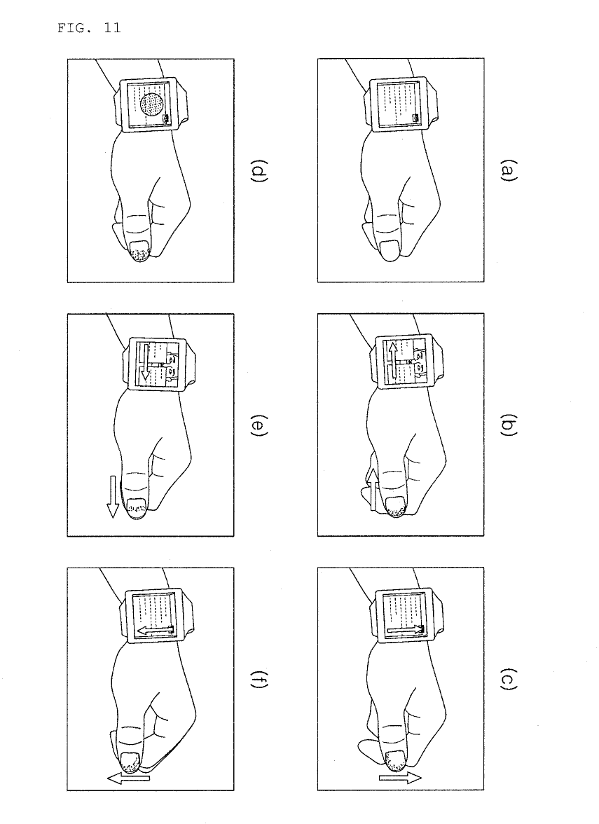

FIG. 11 shows a situation in which a user wears a first device being a smart glass on eyes and issues a control command to a second device being a smart watch according to one embodiment of the invention. Here, the first device is not shown.

The user may look at the second device worn on the user's wrist with the first device being worn on eyes. In this situation, the fingernail of the thumb may be observed as shown. When the color of the observed fingernail is not particularly changed, the visual information analysis unit 110 of the first device may recognize that the user is issuing a standby command to the second device (see (a) of FIG. 11). However, when the end of the observed fingernail is changed to have a white color, the visual information analysis unit 110 may recognize that the user is issuing a selection command to the second device (see (d) of FIG. 11). The selection command may be intended to select an area on the second device.

Meanwhile, the user may use the thumb to provide a directional input to the second device. For example, as in the case of (b) of FIG. 11, the thumb may be brought toward the other fingers (see the arrow pointing left) to cause leftward scrolling on a screen of the second device. On the contrary, as in the case of (e) of FIG. 11, the thumb may be brought away from the other fingers (see the arrow pointing right) to cause rightward scrolling on the screen of the second device. Further, upward scrolling may be caused as in the case of (c) of FIG. 11, or downward scrolling may be caused as in the case of (f) of FIG. 11. In these two cases, a partial color change in the fingernail of the thumb may be detected as well. In the former case, one lateral portion of the fingernail (which is in the lower part of the drawing) and the portion around the end thereof may be changed to have a white color. In the latter case, one lateral portion of the fingernail (which is in the upper part of the drawing) and the portion around the end thereof may be changed to have a white color.

2. Examples of determination based on information on an action performed or a form made by a user and visual information on the user's fingernails or the like

A first element of a user input may be determined according to the user's action or the form of the user's body part, and a second element of the user input may be determined according to a change in the color or the like of the user's fingernails or toenails. One example of the user's action intended therefor may be changing the color of the fingernails by means of a finger action as mentioned in one of the cases (1) to (5) above, before or after performing a specific action or making a specific form with the user's fingers.

The embodiments according to the invention as described above may be implemented in the form of program instructions that can be executed by various computer components, and may be stored on a computer-readable recording medium. The computer-readable recording medium may include program instructions, data files, data structures and the like, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be changed to one or more software modules to perform the processes of the present invention, and vice versa.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method comprising the steps of:
acquiring first information on an action performed or a form made by a user and second information on the user's fingernails or toenails, wherein the second information is visual information; and
determining the user's input by determining a first element of the user's input on the basis of the first information and determining a second element of the input on the basis of the second information.

2. The method of claim 1, wherein the action or form is an action or form of fingers corresponding to the fingernails or toes corresponding to the toenails.

3. The method of claim 1, wherein the second information is acquired by an imaging means.

4. The method of claim 1, wherein the second information is acquired by at least one of a pulse wave sensor, a PPG sensor, and an oxygen saturation sensor.

5. The method of claim 1, wherein the second information is information on color of the fingernails or toenails, or a change in the color thereof.

6. The method of claim 1, wherein the determined user input is selection, operation, and one of interruption and cancellation of one of selection and operation.

7. The method of claim 1, wherein the determined user input is generated by the user pressing fingers of the fingernails or toes of the toenails against an external device.

8. The method of claim 1, wherein the determined user input is generated by the user bending or straightening fingers of the fingernails or toes of the toenails.

9. The method of claim 1, wherein the second information is information on the user's fingernail, and
the determined user input is generated by the user pressing at least two fingers against each other without depending on an object, the fingernail corresponding to one of the at least two fingers.

10. A device comprising:
a visual information analysis unit for acquiring first information on an action performed or a form made by a user and second information on the user's fingernails or toenails, wherein the second information is visual information; and
a user input determination unit for determining the user's input by determining a first element of the user's input on the basis of the first information and determining a second element of the input on the basis of the second information.

11. The device of claim 10, wherein the action or form is an action or form of fingers corresponding to the fingernails or toes corresponding to the toenails.

12. The device of claim 10, wherein the second information is acquired by an imaging means.

13. The device of claim 10, wherein the second information is acquired by at least one of a pulse wave sensor, a PPG sensor, and an oxygen saturation sensor.

14. The device of claim 10, wherein the second information is information on color of the fingernails or toenails, or a change in the color thereof.

15. The device of claim 10, wherein the determined user input is selection, operation, and one of interruption and cancellation of one of selection and operation.

16. The device of claim 10, wherein the determined user input is generated by the user pressing fingers of the fingernails or toes of the toenails against an external device.

17. The device of claim 10, wherein the determined user input is generated by the user bending or straightening fingers of the fingernails or toes of the toenails.

18. The device of claim 10, wherein the second information is information on the user's fingernail, and
the determined user input is generated by the user pressing at least two fingers against each other without depending on an object, the fingernail corresponding to one of the at least two fingers.
